(19) United States
(12) Patent Application Publication
(10) Pub. No.: US 2025/0367832 A1
(43) Pub. Date: Dec. 4, 2025

(54) Non-Disruptive Robotic Arm for Intrusive Sensors in Pressurized Pipes

(71) Applicant: The Hong Kong University of Science and Technology, Hong Kong (CN)

(72) Inventors: Oussama CHOURA, Hong Kong (CN); Moez LOUATI, Schiedam (NL)

(21) Appl. No.: 19/223,394

(22) Filed: May 30, 2025

Related U.S. Application Data
(60) Provisional application No. 63/655,826, filed on Jun. 4, 2024.

(51) Int. Cl. B25J 9/16; B25J 9/00; B25J 18/04; B25J 19/02

(52) U.S. Cl. CPC B25J 9/1697; B25J 9/0009; B25J 18/04; B25J 19/026

(57) ABSTRACT

A robotic arm comprises a translation module extendable into a pipe to be detected and configured for positioning sensors within the pipe, an arm-axis rotation module fixed to a distal end of the translation module and rotatable around a first rotation axis, a pipe-axis rotation module fixed to the arm-axis rotation module and rotatable around a second rotation axis, and a detection module for data collection fixed to the pipe-axis rotation module for rotating along with the pipe-axis rotation module around the second rotation axis.

### CROSS-REFERENCE TO RELATED APPLICATIONS

This application claims priority to the U.S. provisional patent application Ser. No. 63/655,826, filed Jun. 4, 2024, entitled “Non-disruptive robotic arm for intrusive sensors in pressurized pipes”, hereby incorporated herein by reference as to its entirety.

### TECHNICAL FIELD

The present disclosure generally relates to a robotic arm, and in particular to a non-disruptive robotic arm for data collection inside pipelines.

### BACKGROUND

Data collection may often be carried out in a confined and hazardous space which is not accessible by a human being; accordingly, data collection equipment needs to be deployed therein mechanically. For instance, pressurized conduits transporting fluids such as freshwater, seawater, stormwater, wastewater, oil and others are often prone to defects such as wall thinning, leaks or blockages over their operational lifespan due to physical/mechanical stresses and chemical interactions. These defects result in tremendous wastage of energy and financial resources, a reduction in carrying capacity, and an increased potential source of contamination. Identifying defects within a pressurized pipe system requires the acquisition of an ample amount of precise data for a thorough analysis, and herein lies the challenge.

Traversing the suspected defective pipe with conventional devices involves either advection or the use of a tether. This deployment process is commonly slow, disruptive, expensive, and leads to system downtimes. Additionally, the results obtained regarding the presence of defects are often inconclusive.

It is vitally important to create and conceptualize a pipe inspection tool that is economical, efficient, stable and reliable to address the requirements of rigorous inspection tasks and data collection for assessment arising from the continuous expansion of pipelines each year.

Accordingly, this application intends to propose a novel approach and technology using robotic arms to collect high-frequency data, allowing the accurate imaging of a piping system and defect detection.

### SUMMARY

The present disclosure discloses a device that enables the efficient introduction of an in-pipe sensor for collecting Multi-Input-Multi-Output (MIMO) high-frequency data without disrupting the system. It eliminates the need for a roving mechanism and enables mm-scale time reversal (TR) imaging.

One or more embodiments provide a non-disruptive robotic arm that allows non-disruptive sensor intrusion in a confined space, e.g., pressurized water pipelines. Such a non-disruptive robotic arm (or robotic arm) is uniquely designed for sensor insertion and data collection, e.g., collection of high-frequency (HF) multi-input-multi-output data for pipeline imaging. The robotic arm can introduce hydrophones and/or transducers and use high precision (e.g., 0.1 mm) control of linear actuators and robotic motors to span the entire cross-section of the pipe. While respecting the safety and regional and international regulations, the robotic arm, when equipped with the appropriate sensors, permits the collection of acoustic signals, pressure measurements and image frames from the inside of a pipe for the diagnosis/assessment of its condition. The robotic arm of the application may insert securely high-sensitivity pressure sensors through an access point (e.g. an inspection tee) into a pipe to diagnose or image, in other words, to identify sizes and/or locations of defects of the pipe, such as leak, wall thinning, and blockage. It positions the sensors in different locations sweeping the cross-sectional area of the pipe in radial, azimuthal, and axial directions to ensure an expanded range and a high-resolution imaging while the probed pipeline is in-service (non-disrupted), during which the robotic arm directs the sensors axially, for example, against the flow in the pipe or in same direction as the flow. The sensors act as an acoustic signal emitter and receiver. The robotic arm of the application can be used solely or in pairs, where one acts as a transmitter and the other as a receiver, and vice versa. When equipped with the appropriate sensors, it can accurately probe a pipe, gather enough MIMO data to detect a defective pipe and assess its condition using acoustic imaging techniques without causing any disruption to the flow and water supply through the pipe.

The robotic arm according to one or more embodiments of the present disclosure acts like a transmitter and a receiver when it is equipped with two sensors that are capable of generating and detecting high-frequency signals (10 to 100 kHz) with a short wavelength of a few centimeters. Furthermore, the robotic arm collects data in different positions, sweeping the cross-sectional area of the pipe to probe, which allows higher-resolution imaging. The process is considered non-intrusive as the robotic arm penetrates pressurized pipes only at local access points without system interruption. It is equipped with motion mechanisms to achieve the full sweep of the cross-sectional area without causing any turbulence or change in the flow characteristics, with the preservation of accurate measurement and imaging. The robotic arm according to one or more embodiments of the present disclosure can be installed at specific locations and specially designed access points. It can be used in a solo model where the robotic arm acts simultaneously as transmitter and receiver, or in pair mode where one device acts as a receiver and the other as a transmitter.

The penetrating robotic arm has three degrees of freedom: extension, rotation around its own axis, and rotation around the pipe axis. According to one or more embodiments, the robotic arm consists of four modules. The first module comprises a linear actuator. The second is a mechanism to ensure the rotation around its axis (longitudinal axis of the robotic arm) equipped with a high-pressure-withstanding motor (up to 20 bar). The third module is a second rotating mechanism that ensures the rotation around the pipe axis. And finally, a module that holds the transducers (i.e., sensors). These modules are interchangeable. In some embodiments, all of the components are made of a food-grade, highly non-corrosive material that follows and respects all regulations regarding its use within potable water transportation systems. All motions may be remotely controlled.

The robotic arm according to one or more embodiments of the present disclosure is an in-service, non-intrusive, safe, fast and accurate measurement tool that withstands high pressures and flow conditions that are automatically triggered (automated process).

### BRIEF DESCRIPTION OF THE DRAWINGS

Exemplary embodiments of the disclosure are described in the following with respect to the attached figures. The figures and corresponding detailed description serve merely to provide a better understanding of the disclosure and do not constitute a limitation whatsoever of the scope of the disclosure as defined in the claims. In particular:

FIG. 1a is a perspective view of an example of a pipe to be diagnosed or to probe.

FIG. 1b is a cross-sectional view of the pipe of FIG. 1a, wherein a robotic arm is applied according to certain embodiments of the present disclosure.

FIG. 1c illustrates schematically an arrangement of modules of a robotic arm according to certain embodiments of the present disclosure.

FIG. 2 illustrates schematically how a defect on the pipe wall affects the propagation of signals inside the pipe according to certain embodiments of the present disclosure.

FIG. 3 illustrates a perspective view of a translation module of a robotic arm according to certain embodiments of the present disclosure.

FIG. 4 illustrates schematically three modules included in the robotic arm according to certain embodiments of the present disclosure.

### DETAILED DESCRIPTION

The following detailed description is merely exemplary in nature and is not intended to limit the invention or the present disclosure and uses of the invention. Furthermore, there is no intention to be bound by any theory presented in the preceding background of the invention or the following detailed description. It is the intent of the present embodiments to present a device and method for defining a structure to provide a volume in a collapsible tubular structure, such as a lumen.

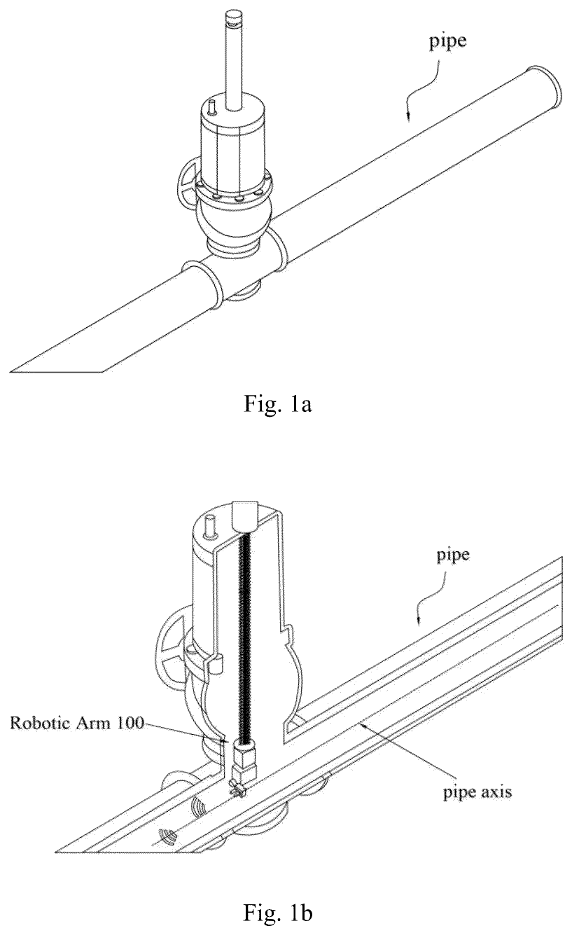

FIG. 1a is a perspective view of an example of a pipe to be diagnosed or probed, which may be buried underground. FIG. 1b is a cross-sectional view of the pipe of FIG. 1a, wherein a robotic arm 100 according to certain embodiments of the present disclosure is applied at a specially designed access point.

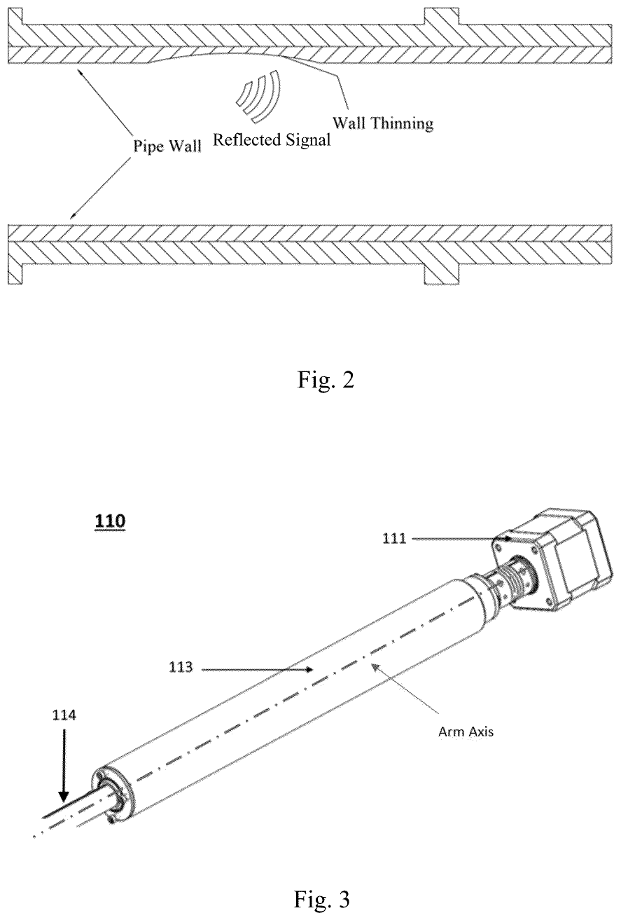

FIG. 1c illustrates schematically a robotic arm 100 according to certain embodiments of the present disclosure. As illustrated, the robotic arm 100 comprises: a translation module 110 including a linear actuator 113, which efficiently converts rotational motion from a stepper motor (shown in FIG. 3) into precise linear movement through ball bearings along a helical raceway; an arm-axis rotation module 120, which is detachably fixed to an distal end of the linear actuator 113 and rotatable around a first rotation axis, i.e., the longitudinal axis of the linear actuator 113 (i.e., arm-axis), as indicated by arrow A; a pipe-axis rotation module 130, which is detachably fixed to the arm-axis rotation module 120 and is rotatable around its rotation axis, i.e., a second rotation axis in line with the pipe axis, as indicated by arrow B, wherein the second rotation axis is oriented differently from the first rotation axis, preferably orthogonal to the arm axis; and a detection module, which is detachably fixed to the pipe-axis rotation module 130 and is able to rotate along with the pipe-axis rotation module 130 around the second rotation axis (indicated by arrow B) and the first rotation axis (indicated by arrow A), for data collection.

Referring back to FIG. 1b, in some embodiments, the detection module may be a sensors module 140, and acoustic signals may be emitted from the sensors module 140, the acoustic signals will be reflected by the wall of the pipe. A distance away along the pipe, there is arranged a second robotic arm 100 (not shown), the sensors module of this second robotic arm 100 is able to receive the acoustic signals, in addition to emitting signals, from the first robotic arm 100 for further analysis for identification of defects on the pipe wall.

Although in FIG. 1b, the sensors module 140 emits acoustic signals towards one direction along the pipe axis, it may also rotate around the arm axis by about 180 degrees so as to emit acoustic signals towards the opposite direction of the pipe. In addition to acoustic signals, the sensors module 140 may also emit and/or receive other types of signals, e.g., electromagnetic signals.

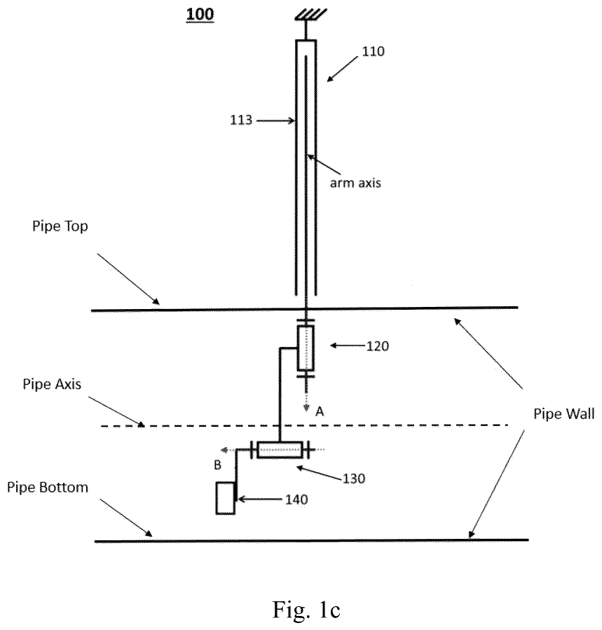

Signals emitted from the sensors module 140 of a first robotic arm 100 will be repeatedly reflected by a defect. The nature, size and location of a defect reflect on the direction and/or amplitude of the reflected signals, resulting in a change of the signals received by a sensor at the second robotic arm 100 arranged at a distance from the first robotic arm 100, in this way, the defect on the pipe wall can be identified through mathematical processes. FIG. 2 schematically illustrates an example of a kind of defect on the pipe wall, i.e., a wall thinning, which will affect the direction in which signals are reflected.

In some embodiments, modules 120, 130 and 140 and the shaft 114 may be immersed in water in the pipe being diagnosed or probed. The rest of the translation module (namely 113 and 111) are not supposed to touch the water.

In some embodiments, the robotic arm 100 further includes a command module (e.g., a computer) (not shown) to control the modules of the robotic arm 100, including precise positioning of each of the modules 123 and 130. The command module is connected via cable to each module, and a user can locally instruct each module via the command module. In other embodiments, a user may also remotely and/or wirelessly instruct each module by means of wireless access to the command module.

In some embodiments, the second rotation axis of the pipe-axis rotation module 130 is configured to be orthogonal to the first rotation axis. The robotic arm 100 may penetrate a pipe to be detected along the longitudinal axis of the linear actuator 113 indicated by arrow A as shown in FIGS. 1b and 1c, which is in orthogonal to the longitudinal axis of the pipe, and accordingly the pipe-axis rotation module 130 is oriented to be parallel to the wall of the pipe, and the sensors module 140 may emit acoustic signals inside the pipe while rotating around the axis of rotation module 130.

The robotic arm 100 also comprises a stepper motor 111, which is illustrated in FIG. 3. The stepper motor 11 along with the linear actuator 113 constitute the translation module 110, as depicted in FIG. 3. Engineered with close tolerances, the translation module 110 ensures high precision, making it ideal for accurately positioning sensors within pipes for probing applications.

In some embodiments, the translation module 110 operates as a self-contained ball screw linear actuator.

In some embodiments, the robotic arm 100 may also comprise a data processing unit (not shown) for processing data collected by the sensors module 140 to identify the potential defects therein, and a data storage (not shown) for storing the data collected by the sensors module 140. The data processing unit may receive data from the sensors module 140 in either a wireless or wired manner. Data or images collected by the sensors module 140 of the robotic arm 100 may be transmitted to a data processing unit for further analysis. The data processing unit may be equipped with a display for displaying images and analysis results.

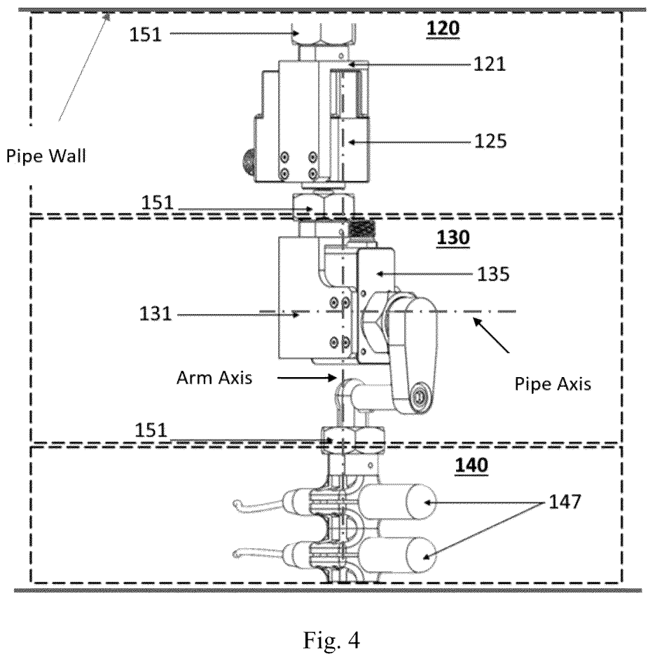

FIG. 4 illustrates schematically the arrangement of 3 modules of the robotic arm 100 according to certain embodiments of the present disclosure.

Referring to FIG. 4, the arm-axis rotation module 120 comprises a first motor holder 121, which may be fixed to the distal end of the translation module 110 via a universal connection; and an arm-axis rotation motor 125, which is installed to the first motor holder 121 and which comprises a rotatable shaft (not shown) oriented in line with the longitudinal axis of the translation module 110, specifically, in line with the longitudinal axis of the linear actuator 113 of the translation module 110.

The pipe-axis rotation module 130 comprises a second motor holder 131, which may be fixed to the arm-axis rotation module 120 via a universal connection; and a pipe-axis rotation motor 135, which is installed to the second motor holder 131 and which comprises a rotatable shaft (not shown) oriented in line with the axis of the pipe to be detected.

The sensors module 140 is fixed to the pipe-axis rotation module 130 and comprises at least one sensor 147, e.g., hydrophones. According to certain embodiments, as shown in FIG. 4, the sensors module 140 serves as a pivotal component; it accommodates two sensors arranged in parallel and stacked vertically for optimal functionality. By incorporating this configuration, it ensures a strategic arrangement of the sensors, allowing for efficient data collection, which contributes to the overall effectiveness of the device.

According to some embodiments, the arm-axis rotation module 120 utilizes a servomotor, preferably a high-precision servomotor, designed to withstand pressures of up to 300 psi. This robust servomotor empowers the sensors to rotate in both directions, i.e., rotating along the direction of arrow B and the opposite, providing a versatile capability for thorough and comprehensive probing of pipes. Whether rotated in the same direction as the flow inside the pipe or against it, this module ensures flexibility in data collection, allowing the robotic arm 100 to effectively acquire enough data in both directions with precision and accuracy.

According to some embodiments, the pipe-axis rotation module 130 is designed to optimize the imaging capabilities of the robotic arm 100 by employing a specialized motor. This motor facilitates the radial rotation of the sensors around the axis of the pipe. Specifically, the motor turns around the pipe Axis (B Arrow), which means the sensors module also turns around the same axis. Now, combining both the rotation around the pipe Axis and the translation movement, the sensor location varies, covering the pipe cross-sectional area. This dynamic movement enhances the imaging resolution significantly, allowing for a more comprehensive and detailed inspection of the pipe's internal structure. By enabling the sensors to capture data from multiple angles, the module contributes to a more thorough understanding of the pipe's condition, aiding in the identification of potential defects. This rotational capability adds another dimension to the data collection process, ensuring a comprehensive assessment and improving the overall effectiveness of the modular apparatus in various inspection scenarios.

The modular device boasts several noteworthy additional features that enhance its functionality and versatility. First and foremost, it is equipped with a cable management system, ensuring seamless extension and rotation of the device without any interference. In some embodiments, the cable management system includes four cables that are integral to the device's functionality. Specifically, there are two motor cables, each connecting to the arm-axis rotation motor 125 and pipe-axis rotation motor 135, respectively, for empowering the motors, and two sensor cables, each linking to a separate sensor 147, for empowering the sensors and transmitting data to/from the sensors. In some embodiments, the cables are attached to a spring system that elongates as linear translating module 110 extends, wherein one end is connected to the actuator fixed part and the other end is connected to the far end of the shaft 114, where module 120 is connected. This design ensures that the cables are guided and do not interfere with each other during movement. This feature facilitates smooth and unhindered operation during maneuvers. Furthermore, the device 100 is designed for remote control via a command module. The remote-control capability adds a layer of convenience and adaptability, particularly in scenarios where real-time adjustments are necessary for optimal performance. In some embodiments, the arm is also equipped with an inspection water-proof flashlight torch camera to monitor the sensors insertion.

Notably, the robotic arm 100 of the present disclosure offers the flexibility of individual or paired use, adapting to varied operational needs in terms of accessibility and installation. This adaptability ensures that the device 100 can be employed efficiently across a spectrum of scenarios, whether as a standalone unit or as part of a synchronized pair. This capability positions the device 100 for applications demanding enhanced sensitivity and accurate data acquisition within a broad frequency spectrum. The two embodiments of standalone unit and in-pair configuration are described below, respectively.

### Standalone Use:

In a standalone configuration, according to certain embodiments, the robotic arm 100, which comprises two sensors 147, assumes a dual role as both an emitter and a receiver. The translation module 110 extends to position the sensors 147 precisely at the pipe axis during in-pipe operations. Here, one sensor 147 functions as an emitter, generating high-frequency acoustic waves that interact with the pipe's geometry or any potential defects. Simultaneously, the second sensor 147 acts as a receiver, capturing the reflections of these waves. The roles of the two sensors alternate, creating a systematic data collection pattern.

As the translation module 110 continues to extend, the robotic arm 100 reiterates the data collection process along the cross section of the pipe, and the specific direction in which the sensors module moves within the cross section depends on which part of the pipe to probe. The device penetrates the pipe, moves the sensors up and down using the actuator 110 and rotates the sensors radially using module 130 around the direction of arrow B. In some embodiments, the sensors may also rotate around the direction of arrow A, driven by module 120. The arm progressively extends further, following the same emission and reception pattern until it reaches the bottom of the pipe (as indicated in FIG. 1c). Subsequently, the pipe-axis rotation module 130 comes into play, allowing the sensors 147 to move radially at a specific angle. This radial movement enables the robotic arm 100 to recollect data systematically, expanding the coverage of the inspected area. The entire process repeats until a comprehensive sweep of the cross-sectional area is accomplished.

This methodical approach to data collection ensures thorough coverage and detailed high-resolution imaging. With one sensor of the device acting as an emitter and the other as the receiver, coupled with radial movement, it enhances its capability to detect and analyze potential anomalies or irregularities within the pipe structure in one direction.

The iterative process continues as the first module intervenes, introducing a rotation of the sensors in the opposite direction, moving from the same flow direction to the opposite. The alternating rotation of the sensors in both directions ensures a thorough examination of the entire pipe. Specifically, for example, if the sensors and the flow are in the same direction, the collected data serves to assess the condition of the part of the pipe from where the robotic arm is installed to the downstream. And if they are one against the other, the data is used to diagnose the part of the pipe from its upstream to the robotic arm location. This dynamic approach enhances the device's ability to detect variations in the pipe's structure or defects, providing a comprehensive and detailed assessment. The repetition of these steps, with rotations in both directions, contributes to the device's effectiveness in acquiring enough high-resolution data for accurate pipe inspection and assessment.

### In-Pair Configuration:

In the in-pair configuration, employing two robotic arms 100 with each of the devices 100 comprising at least one sensor 147, a dynamic interplay unfolds where one device serves as the emitter while the other acts as the receiver, and their roles interchange reciprocally. Just as in the standalone configuration, both robotic arms 100 commence from a common starting position. The emission and collection of high-frequency data initiate, with one device operating as the emitter and the other as the receiver. The receiver remains stationary while the emitter undergoes movement, systematically sweeping across the cross-sectional area of the pipeline.

Upon completion of a sweep, the receiver transitions to the next designated position while the emitter returns to its initial location. The process recommences with the emitter once again in motion, continuing the systematic sweep. This cycle repeats until both sensors have comprehensively covered the cross-sectional area, emitting and collecting data as they progress.

Following this, the entire process repeats, but with a pivotal shift in roles. The devices switch functions, with the previous emitter now becoming the receiver and vice versa. This reciprocal exchange ensures a thorough and complementary inspection, providing comprehensive coverage of the cross-sectional area through multiple iterations. The cyclic nature of these actions optimizes the efficiency and effectiveness of the in-pair configuration in data collection for detailed and accurate pipeline imaging.

A further advantageous effect of the present disclosure is that the robotic arm 100 excels in signal collection by capturing data in various positions. This feature facilitates MIMO functionality, enabling high-resolution imaging through the aggregation of high-frequency acoustic signals from diverse perspectives. This multi-position signal collection ensures a comprehensive and detailed understanding of the inspected environment.

Wherever not already described explicitly, individual embodiments, or their individual aspects and features, described in relation to the drawings can be combined or exchanged with one another without limiting the scope of the described disclosure, whenever such a combination or exchange is meaningful and in the sense of this disclosure. Advantages which are described with respect to a particular embodiment of present disclosure or with respect to a particular figure are, wherever applicable, also advantages of other embodiments of the present disclosure.

What is claimed is:

1. A robotic arm comprising:
a translation module extendable into a pipe to be imaged and configured for positioning sensors within the pipe;
an arm-axis rotation module fixed to a distal end of the translation module and rotatable around a first rotation axis;
a pipe-axis rotation module fixed to the arm-axis rotation module and rotatable around a second rotation axis;
a detection module for data collection fixed to the pipe-axis rotation module for rotating along with the pipe-axis rotation module around the second rotation axis.

2. The robotic arm according to claim 1, wherein the detection module is a sensors module comprising sensors for emitting and receiving acoustic signals.

3. The robotic arm according to claim 1, wherein the second rotation axis is oriented differently from the first rotation axis.

4. The robotic arm according to claim 3, wherein the second rotation axis is orthogonal to the first rotation axis.

5. The robotic arm according to claim 1, wherein the translation module comprises a stepper motor and a linear actuator installed to the stepper motor.

6. The robotic arm according to claim 1, wherein the arm-axis rotation module comprises a first motor holder and an arm-axis rotation motor which is installed to the first motor holder.

7. The robotic arm according to claim 6, wherein the pipe-axis rotation module comprises a second motor holder and a pipe-axis rotation motor which is installed to the first motor holder.

8. The robotic arm according to claim 2, wherein the arm-axis rotation module utilizes a servomotor.

9. The robotic arm according to claim 8, wherein the servomotor is configured to enable the sensors to rotate in two directions.

10. The robotic arm according to claim 2, wherein the pipe-axis rotation module enables the sensors to move radially at a specific angle.

11. The robotic arm according to claim 2, wherein the sensors are hydrophones.

12. The robotic arm according to claim 2, wherein the sensors module comprises two sensors, one of which emits acoustic signals, and the other one receives acoustic signals reflected.

13. The robotic arm according to claim 2, wherein the sensors are configured to collect multi-input-multi-output (MIMO) data to image defects of the pipe.

14. The robotic arm according to claim 13, wherein the defects of the pipe comprise any of leak, wall thinning, and blockage.

15. The robotic arm according to claim 2, further comprising:
a data processing unit for processing data collected by the sensors to identify potential defects therein; and
a data storage for storing data collected by the sensors.
